(19) United States
(12) Patent Application Publication
(10) Pub. No.: US 2007/0266322 A1
(43) Pub. Date: Nov. 15, 2007

(54) VIDEO BROWSING USER INTERFACE

(76) Inventors: Daniel R. Tretter, San Jose, CA (US); Tong Zhang, San Jose, CA (US); Simon Widdowson, Dublin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/433,659

(22) Filed: May 12, 2006

(51) Int. Cl. G06F 9/00

(52) U.S. Cl. 715/716; 715/719; 715/764

(57) ABSTRACT

An exemplary system for browsing videos comprises a memory for storing a plurality of videos, a processor for accessing the videos, and a video browsing user interface for enabling a user to browse the videos. The user interface is configured to enable video browsing in multiple states on a display screen, including a first state for displaying static representations of the videos, a second state for displaying dynamic representations of the videos, and a third state for playing at least a portion of a selected video.

### BACKGROUND

A digital video stream can be divided into several logical units called scenes, where each scene includes a number of shots. A shot in a video stream is a sequence of video frames obtained by a camera without interruption. Video content browsing is typically based on shot analyses.

For example, some existing systems analyze the shots of a video to extract key-frames representing the shots. The extracted key-frames then can be used to represent a summary of the video. Key-frame extraction techniques do not necessarily have to be shot dependent. For example, a key-frame extraction technique may extract one out of every predetermined number of frames without analyzing the content of the video. Alternatively, a key-frame extraction technique may be highly content-dependent. For example, the content of each frame (or selected frames) may be analyzed then content scores can be assigned to the frames based on the content analysis results. The assigned scores then may be used for extracting only frames scoring higher than a threshold value.

Regardless of the key-frame extraction techniques used, the extracted key-frames are typically used as a static summary (or storyboard) of the video. For example, in a typical menu for a video, various static frames are generally displayed to a user to enable scene selections. When a user selects one of the static frames, the video player automatically jumps to the beginning of the scene represented by that static frame.

The one-dimensional storyboard or summary of a video typically requires a large number of key-frames to be displayed at the same time in order to adequately represent the entire video. Thus, this type of video browsing requires a large display screen and is not practical for small screen displays (e.g., a PDA) and generally does not allow a user to browse multiple videos at the same time (e.g., to determine which video to watch).

Some existing systems may allow a user to view static thumbnail representations of multiple videos on the same screen. However, if a user wishes to browse the content of any one video, he/she typically has to select one of the videos (by selecting a thumbnail image) and navigate to the next display window (replacing the window having the thumbnails) to see static frames (e.g., key-frames) of that video.

Thus, a market exists for a video browsing user interface that enables a user to more easily browse multiple videos on one display screen.

### SUMMARY

An exemplary system for browsing videos comprises a memory for storing a plurality of videos, a processor for accessing the videos, and a video browsing user interface for enabling a user to browse the videos. The user interface is configured to enable video browsing in multiple states on a display screen, including a first state for displaying static representations of the videos, a second state for displaying dynamic representations of the videos, and a third state for playing at least a portion of a selected video.

An exemplary method for generating a video browsing user interface comprises obtaining a plurality of videos, obtaining key-frames of each video, selecting a static representation of each video from the corresponding key-frames of the video, obtaining a dynamic representation of each video, and creating a video browsing user interface based on the static representations, the dynamic representations, and the videos to enable a user to browse the plurality of videos on a display screen.

Other embodiments and implementations are also described below.

### BRIEF DESCRIPTION OF THE FIGURES

FIG. 1 illustrates an exemplary computer system for displaying an exemplary video browsing user interface.

FIG. 2 illustrates an exemplary first state of the exemplary video browsing user interface

FIG. 3 illustrates an exemplary second state of the exemplary video browsing user interface.

FIG. 4 illustrates an exemplary third state of the exemplary video browsing user interface.

FIG. 5 illustrates an exemplary process for generating an exemplary video browsing user interface.

### DETAILED DESCRIPTION

I. Overview

Section II describes an exemplary system for an exemplary video browsing user interface.

Section III describes exemplary states of the exemplary video browsing user interface.

Section IV describes an exemplary process for generating the exemplary video browsing user interface.

Section V describes an exemplary computing environment.

II. An Exemplary System for an Exemplary Video Browsing User Interface

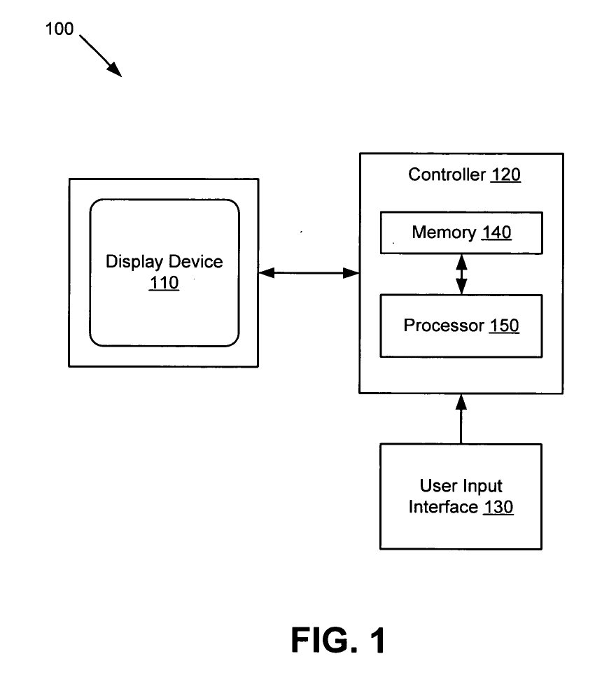

FIG. 1 illustrates an exemplary computer system 100 for implementing an exemplary video browsing user interface. The system 100 includes a display device 110, a controller 120, and a user input interface 130. The display device 110 may be a computer monitor, a television screen, or any other display devices capable of displaying a video browsing user interface for viewing by a user. The controller 120 includes a memory 140 and a processor 150.

In an exemplary implementation, the memory 140 may be used to store a plurality of videos, key-frames of the videos, static representation (e.g., representative images) of each video, dynamic representations (e.g., slide shows) of each video, and/or other data related to the videos, some or all of which may be usable in the video browsing user interface to enhance the user browsing experience. Additionally, the memory 140 may be used as a buffer for storing and processing streaming videos received via a network (e.g., the Internet). In another exemplary embodiment (not shown), an additional external memory accessible to the controller 120 may be implemented to store some or all of the above-described data.

The processor 150 may be a CPU, a micro-processor, or any computing device capable of accessing the memory 140 (or other external memories, e.g., at a remote server via a network) based on user inputs received via the user input interface 130.

The user input interface 130 may be implemented to receive inputs from a user via a keyboard, a mouse, a joystick, a microphone, or any other input device. A user input may be received by the processor 150 for activating different states of the video browsing user interface.

The controller 120 may be implemented in a terminal computer device (e.g., a PDA, a computer-enabled television set, a personal computer, a laptop computer, a DVD player, a digital home entertainment center, etc.) or in a server computer on a network (e.g., an internal network, the Internet, etc.).

Some or all of the various components of the system 100 may reside locally or at different locations in a networked and/or distributed environment.

III. An Exemplary Video Browsing User Interface

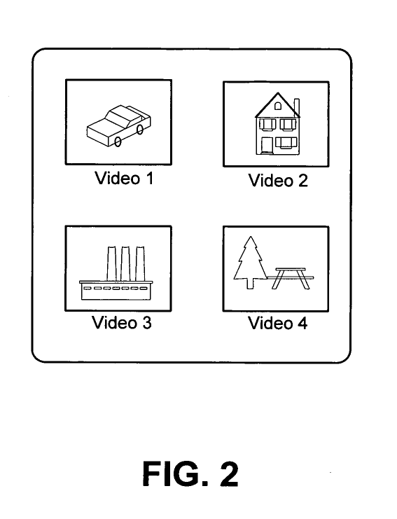

An exemplary video browsing user interface includes multiple states. For example, in an exemplary implementation, the video browsing user interface may include three different states. FIGS. 2-4 illustrate three exemplary states of an exemplary video browsing user interface for use to browse a set of videos.

FIG. 2 illustrates an exemplary first state of a video browsing user interface. In an exemplary implementation, the first state is the default state first viewed by a user who navigates to (or otherwise invokes) the video browsing user interface. In an exemplary embodiment, the first state displays a static representation of each of a set of videos. For example, the exemplary first state illustrated in FIG. 2 displays a representative image of each of four videos. More or less representative images of videos may be displayed depending on design choice, user preferences, configuration, and/or physical constraints (e.g., screen size, etc.). Each static representation (e.g., a representative image) represents a video. In an exemplary implementation, a static representation for each video may be selected from the key-frames of the corresponding video. Key-frame generation will be described in more detail in Section IV below. For example, the static representation of a video may be the first key-frame, a randomly selected key-frame, or a key-frame selected based on its relevance to the content of the video.

In FIG. 2, the static representation of video 1 is an image of a car, the static representation of video 2 is an image of a house, the static representation of video 3 is an image of a factory, and the static representation of video 4 is an image of a park. These representations are merely illustrative. As a user moves a curser over each of these four images, the video browsing interface may change to a second state. Alternatively, to activate a second state, the user may have to select (e.g., by clicking on a mouse, or hitting the enter button on the keyboard, etc.) a static representation. Thus, the video browsing interface may be configured to automatically activate a second state upon detection of the curser (or other indicator) or upon receiving other appropriate user input.

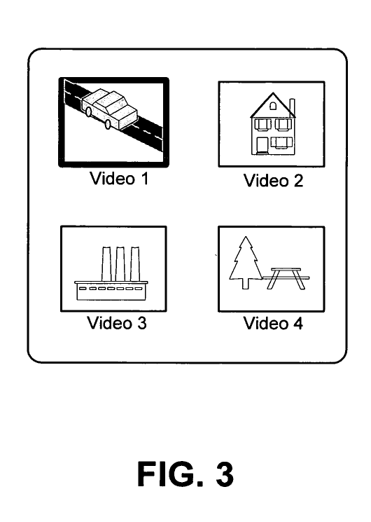

FIG. 3 illustrates an exemplary second state of a video browsing user interface. For example, after receiving an appropriate user selection, or upon the detection of the curser, a second state may be activated for the selected video. In an exemplary embodiment, the second state displays a dynamic representation of a selected video. For example, in an exemplary implementation, if video 1 is selected, a slide show of video 1 is continuously displayed until the user moves the curser away from the static representation of video 1 (or if the user otherwise deselects video 1). The dynamic representation (e.g., a slide show) of a selected video may be displayed in the same window as that of the static representation of the video. That is, the static representation is replaced by the dynamic representation. Alternatively, the dynamic representation of a video may be displayed in a separate window (not shown). In an exemplary implementation, the frame of the static representation of a selected video may be highlighted as shown in FIG. 3.

A dynamic representation, such as a slide show, of a video may be generated by selecting certain frames from its corresponding video. Frame selection may or may not be content based. For example, any key-frame selection techniques known in the art may be implemented to select the key-frames of a video for use in a dynamic representation. An exemplary key-frame selection technique will be described in more detail in Section IV below. For any given video, after its key-frames have been selected, some or all of the key-frames may be incorporated into a dynamic representation of the video. The duration of each frame (e.g., a slide) in the dynamic representation (e.g., a slide show) may also be configurable.

In an exemplary implementation, the dynamic representation of a video is a slide show. In one implementation, some or all key-frames of the video may be used as slides in the slide show. The slide show may be generated based on known DVD standards (e.g., described in the well known DVD forum). A slide show generated in accordance with DVD standards can generally be played by any DVD player. The DVD standards are well known and need not be described in more detail herein.

In another implementation, the slide show may be generated based on known W3C standards to create an animated GIF which can be played on any personal computing device. The software and technology for generating animated GIF is known in the art and need not be described in more detail herein (e.g., Adobe Photoshop, Apple iMovie, HP Memories Disk Creator, etc.).

A system administrator or a user may choose to generate a slide show using one of the above, both, or other standards. For example, a user may wish to be able to browse the videos using a DVD player as well as a personal computer. In this example, the user may configure the processor 150 to generate multiple sets of slide shows, each being compliant to a standard.

The implementation of using slide shows as dynamic representations of the videos is merely illustrative. A person skilled in the art will recognize that other types of dynamic representations may be alternatively implemented. For example, a short video clip of each video may be implemented as a dynamic representation of that video.

When a user provides an appropriate input (e.g., by selecting an on-going dynamic representation), a third state may be activated. In an exemplary implementation, the user may also directly activate the third state from the first state, for example, by making an appropriate selection of a video on the static representation of that video. In an exemplary implementation, the user may select a video by double-clicking the static representation or the dynamic representation of the video.

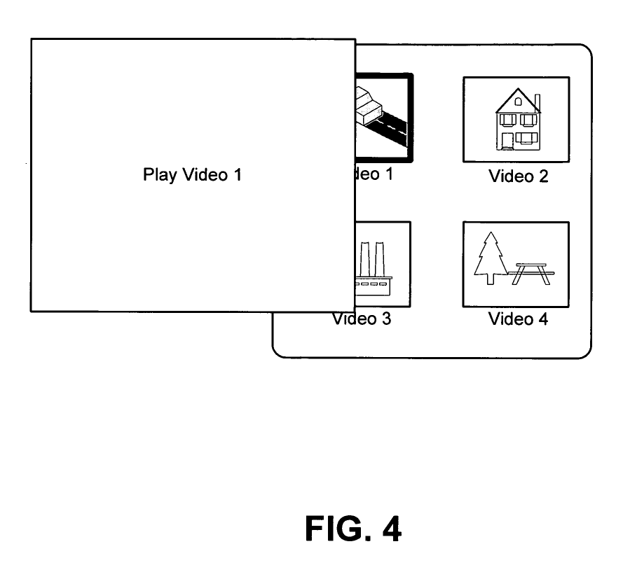

FIG. 4 illustrates an exemplary third state of the video browsing user interface. In an exemplary implementation, as a user appropriately selects either a static representation (first state) or a dynamic representation (second state) of a video to activate the third state, at least a selected portion or the entire video may be played. The video may be played in the same window as that of the static representation of the video (not shown) or may be played in a separate window. The separate window may overlap the original display screen partially or entirely, or may be placed next to the original display screen (not shown). For example, upon user selection, a media player may be invoked (e.g., a window's media player, a DVD player coupled to the processor, etc.) to play the video.

In one implementation, upon receiving a user selection of a video, the entire video may be played (e.g., from the beginning of the video).

In another implementation, upon receiving a user selection of a video, a video segment of the selected video is played. For example, the video segment between a present slide and a next slide may be played. A user may be given a choice of playing a video in its entirety or playing only a segment of the video.

The three exemplary states described above are merely illustrative. A person skilled in the art will recognize that more or less states may be implemented in the video browsing user interface. For example, a fourth state which enables a user to simultaneously see dynamic representations (e.g., slide shows) of multiple videos on the same display screen may be implemented in combination with or to replace any of the three states described above.

IV. An Exemplary Process for Generating the Exemplary Video Browsing User Interface

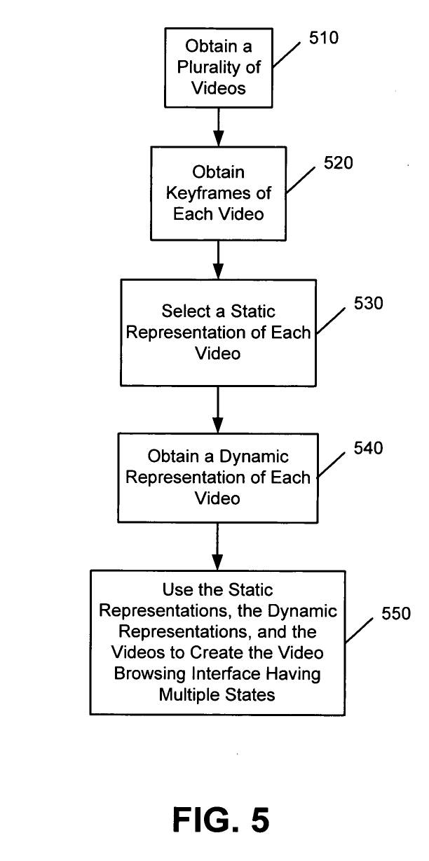

FIG. 5 illustrates an exemplary process for generating the exemplary video browsing user interface.

At step 510, a plurality of videos is obtained by the processor 150. In an exemplary implementation, the videos may be obtained from the memory 140. In another implementation, the videos may be obtained from a remote source. For example, the processor 150 may obtain videos stored in a remote memory or streaming videos sent from a server computer via a network.

At step 520, key-frames are obtained for each video. In one implementation, the processor 150 obtains key-frames extracted by another device (e.g., from a server computer via a network). In another exemplary implementation, the processor 150 may perform a content based key-frame extraction technique. For example, the technique may include the steps of analyzing the content of each frame of a video, then selecting a set of candidate key-frames based on the analyses. The analyses determine whether each frame contains any meaningful content. Meaningful content may be determined by analyzing, for example, and without limitation, camera motion in the video, object motion in the video, human face content in the video, content changes in the video (e.g., color and/or texture features), and/or audio events in the video. Each frame may be assigned a content score after performing one or more analyses to determine whether the frame has any meaningful content. For example, depending on a desired number of slides in a slide show (e.g., as a dynamic representation of a video), extracted candidate key-frames can be grouped into that number of clusters. The key-frame having the highest content score in each cluster can be selected as a slide in the slide show. In an exemplary implementation, candidate key-frames having certain similar characteristics (e.g., similar color histogram) can be grouped into the same cluster. Other characteristics of the key-frames may be used for clustering. The key-frame extraction technique described is merely illustrative. One skilled in the art will recognize that any frame (i.e., key-frame or otherwise) or frames of a video may be used to generate a static or dynamic representation. In addition, when key-frames are used, any key-frame extraction techniques may be applied. Alternatively, the processor 150 may obtain extracted key-frames or already generated slide shows for one of more of the videos from another device.

At step 530, a static representation of each video is selected. In an exemplary implementation, a static representation is selected for each video from among the obtained key-frames. In one implementation, the first key-frame of each video is selected as the static representation. In another implementation, depending on the key-frame extraction technique used, if any, a most relevant or “best” frame may be selected as the static representation. The selected static representations will be displayed as the default representations of the videos in the video browsing user interface.

At step 540, a dynamic representation of each video is obtained. In an exemplary implementation, a slide show for each video is obtained. In one implementation, the processor 150 obtains dynamic representations (e.g., slide shows) for one or more of the videos from another device (e.g., a remote server via a network). In another implementation, the processor 150 generates a dynamic representation for each video based on key-frames for each video. For example, a dynamic representation may comprise some or all key-frames of a video. In one implementation, a dynamic representation of a video may comprise some key-frames of the video based on the content of each key-frame (e.g., all key-frames above a certain threshold content score may be included in the dynamic representation). The dynamic representations can be generated using technologies and standards known in the art (e.g., DVD forum, W3C standards, etc.). The dynamic representations can be activated as an alternative state of the video browsing user interface.

At step 550, the static representations, the dynamic representations, and the videos are stored in memory 140 to be accessed by the processor 150 depending on user input while browsing videos via the video browsing user interface.

V. An Exemplary Computing Environment

The techniques described herein can be implemented using any suitable computing environment. The computing environment could take the form of software-based logic instructions stored in one or more computer-readable memories and executed using a computer processor. Alternatively, some or all of the techniques could be implemented in hardware, perhaps even eliminating the need for a separate processor, if the hardware modules contain the requisite processor functionality. The hardware modules could comprise PLAs, PALs, ASICs, and still other devices for implementing logic instructions known to those skilled in the art or hereafter developed.

In general, then, the computing environment with which the techniques can be implemented should be understood to include any circuitry, program, code, routine, object, component, data structure, and so forth, that implements the specified functionality, whether in hardware, software, or a combination thereof. The software and/or hardware would typically reside on or constitute some type of computer-readable media which can store data and logic instructions that are accessible by the computer or the processing logic. Such media might include, without limitation, hard disks, floppy disks, magnetic cassettes, flash memory cards, digital video disks, removable cartridges, random access memories (RAMs), read only memories (ROMs), and/or still other electronic, magnetic and/or optical media known to those skilled in the art or hereafter developed.

VI. Conclusion

The foregoing examples illustrate certain exemplary embodiments from which other embodiments, variations, and modifications will be apparent to those skilled in the art. The inventions should therefore not be limited to the particular embodiments discussed above, but rather are defined by the claims. Furthermore, some of the claims may include alphanumeric identifiers to distinguish the elements and/or recite elements in a particular sequence. Such identifiers or sequence are merely provided for convenience in reading, and should not necessarily be construed as requiring or implying a particular order of steps, or a particular sequential relationship among the claim elements.

What is claimed is:

1. A system for browsing videos, comprising:
a memory for storing a plurality of videos;
a processor for accessing said videos; and
a video browsing user interface for enabling a user to browse said videos, said user interface being configured to enable video browsing in multiple states on a display screen, including:
a first state for displaying static representations of said videos;
a second state for displaying dynamic representations of said videos; and
a third state for playing at least a portion of a selected video.

2. The system of claim 1, wherein said memory includes a representative image as a static representation for each of said videos.

3. The system of claim 1, wherein said memory includes a slide show as a dynamic representation of each of said videos.

4. The system of claim 1, wherein said memory includes key-frames as a dynamic representation of each of said videos.

5. The system of claim 1, wherein said third state includes opening a new display window within said display screen for playing at least a portion of said video.

6. The system of claim 1, wherein said third state includes playing the entire selected video.

7. The system of claim 1, wherein said static representation of a video is chosen from a set of key-frames of the video.

8. The system of claim 1, further comprising a fourth state for displaying two or more dynamic representations of said videos simultaneously in the display screen.

9. A method for generating a video browsing user interface, comprising:
obtaining a plurality of videos;
obtaining key-frames of each video;
selecting a static representation of each video from the corresponding key-frames of said video;
obtaining a dynamic representation based on said key-frames of each video; and
creating a video browsing user interface based on said static representations, said dynamic representations, and said videos to enable a user to browse said plurality of videos on a display screen.

10. The method of claim 9, wherein a first state of said user interface includes displaying static representations of said plurality of videos.

11. The method of claim 9, wherein a second state of said user interface includes displaying a dynamic representation of one of said plurality of videos whose static representation has been selected by a user.

12. The method of claim 9, wherein said dynamic representation of each video is a slide show of the video.

13. The method of claim 9, wherein a third state of said user interface includes playing at least a portion of a selected video.

14. The method of claim 9, wherein said selecting includes:
obtaining a content score for each key-frame based on its content; and
selecting a key-frame of each video having the highest content score compared to the content scores of the other key-frames for the video.

15. The method of claim 9, wherein a fourth state of said user interface includes displaying two or more dynamic representations of said videos simultaneously.

16. A computer-readable medium for generating a video browsing user interface, comprising logic instructions that, when executed:
obtain a plurality of videos;
obtain key-frames of each video;
select a static representation of each video from the corresponding key-frames of said video;
obtain a dynamic representation of each video; and
create a video browsing user interface based on said static representations, said dynamic representations, and said videos to enable a user to browse said plurality of videos on a display screen.

17. The computer-readable medium of claim 16, wherein a first state of said user interface includes displaying static representations of said plurality of videos.

18. The computer-readable medium of claim 16, wherein said dynamic representation of each video is a slide show of the video.

19. The computer-readable medium of claim 16, wherein said dynamic representation of each video is generated based on key-frames of the video.

20. The computer-readable medium of claim 16, wherein a third state of said user interface includes playing at least a portion of a selected video.
